(19) United States
(12) Patent Application Publication
(10) Pub. No.: US 2010/0100442 A1
(43) Pub. Date: Apr. 22, 2010

(54) Methods and Systems for Programmably Generating Electronic Aggregate Creatives for Display on an Electronic Network

(75) Inventors: Bret Alan Gorsline, Flemington, NJ (US); Ron Hyman Rothman, Ringoes, NJ (US)

Correspondence Address: NIXON PEABODY, LLP, 401 9TH STREET, NW, SUITE 900, WASHINGTON, DC, 20004-2128, US

(73) Assignee: CBS INTERACTIVE, INC., Wilmington, DE (US)

(21) Appl. No.: 12/642,850

(22) Filed: Dec. 20, 2009

Related U.S. Application Data
(63) Continuation of application No. 10/727,264, filed on Dec. 3, 2003.

(51) Int. Cl. G06Q 30/00; G06F 15/16; G06F 17/00; G06F 17/30

(52) U.S. Cl. 705/14.53; 705/14.55; 705/14.67; 705/14.72; 709/203; 715/205; 707/802; 707/E17.044

(57) ABSTRACT

Methods and systems are provided for automatically creating large numbers of aggregate creative forms, in accordance with corresponding definitions, each aggregate creative form containing one or more groupings of zero or more subcreatives. The aggregate creative definition may comprise a template, software program or data file. Rotation is provided at two levels: the subcreatives may change within the aggregate creative forms and the aggregate creative as a whole may share a page location with other advertisements. Constraints may be applied to control which subcreatives appear concurrently. Aggregate creative definitions are reusable, subcreatives may be targeted narrowly or generally, and formatting considerations are applied. Methods and systems are provided for serving aggregate creatives over the Internet which take advantage of the benefits and features of the Internet to deliver those creatives in accordance with the capabilities of a standard advertising system.

### CROSS REFERENCE TO RELATED APPLICATIONS

This invention is related to copending U.S. patent application Ser. No. 10/681,476 filed on Oct. 8, 2003 by Rothman R. and Gorsline B. and titled METHODS AND SYSTEMS FOR PROGRAMMABLY GENERATING ELECTRONIC CREATIVES FOR DISPLAY ON AN ELECTRONIC NETWORK, the entirety of which is incorporated herein by reference.

### FIELD OF THE INVENTION

The present invention relates to the programmable generation of electronic creatives such as advertisements for display to users of an electronic network.

### BACKGROUND OF THE INVENTION

The Internet, and in particular the World Wide Web portion of the Internet, has become a pervasive and fast-growing channel for many forms of electronic information distribution and exchange. It is widely used to distribute content, support different forms of communications and to enable commerce. In fact, commerce performed on the Internet has developed its own special designator: electronic commerce, or e-commerce.

Electronic advertising has grown to play a significant role in e-commerce on the Internet. Advertising has the ability to provide useful information directly to a potential viewer. Advertising can facilitate the finding of goods and services. It can communicate necessary and important information to a viewer, to some extent making up for the lack of direct physical contact between viewers and products. Advertisements can serve as electronic links through the inclusion of an HTML hyperlink enabling a viewer to directly download purchase information and consummate an online transaction.

Further, electronic advertising can serve as a significant source of revenue to online publishers. Many companies are willing to pay publishers, under many different types of arrangements, for their value as an advertising channel.

Unlike traditional press, radio and television advertising, which is generally fixed in content and overly broad in distribution, electronic advertising has some ability to be adjusted and targeted to very specific buying groups. For example, in radio, television, print and direct mailing, advertising is often created or selected for a relatively broad market and then mass distributed. It is not cost-effective, for example, to create one television ad for a very narrow audience. Nor can a narrowly targeted television advertisement be effectively transmitted only to a small audience.

In contrast, many different advertisements can be cost-effectively prepared and stored for selection and distribution over the Internet. Further, based on determinable actions of an online viewer, particular advertisements can be selected and cost-effectively displayed down to the level of a single, individual viewer. Many methods are known, to those skilled in the art, of identifying online viewer interests and dynamically selecting and serving an appropriate advertisement.

It is thus seen that the Internet provides significant and fast-growing opportunities for e-commerce. Further, the Internet provides unique abilities to identify and communicate with large numbers of users, on an individual basis, substantially instantaneously and inexpensively.

While the evaluation of online viewer behavior is not the subject of this invention, the creation and serving of online advertising is directly pertinent. For purposes of explanation, advertising content is referred to herein as “creative(s),” the two terms being used interchangeably.

In the opinion of the present inventors, the types of electronic advertisements that provide the greatest utility in supporting many different business models share one or more of the several different properties described below.

One property is tracking, which is the ability to count the number of times a user views and interacts with (e.g., clicks on) the creative. Robust systems count only valid impressions (i.e., views) and clicks, filtering out those generated by software rather than people.

Another property is that of rotation, allowing several advertisers to share the same space or position over time. Users thus see different creatives each time they view a particular web page. Similarly, different users visiting the same page might see different creatives. The property of rotation can be seen through a web browser reload or refresh function. If the ad in a given position stays the same through successive page reloads, an advertisement is said to be “fixed.” If the advertisement is different in some way, it is said to be “rotating.”

High-functionality electronic advertising also provides the property of flexible scheduling, enabling a user to define when a given creative should run, and its goal relative to other creatives.

One particular type of electronic advertisement, termed a “compound creative,” combines several different creatives together into a single block. For example, a single box may contain text, links and/or images from several different advertisers. The individual creatives, whether in the form of text, links and/or images, within a compound creative are herein referred to as “subcreatives,” which are collected together within a “container,” which may also include its own text, links, and/or images.

When compared with “conventional creatives” (i.e., non-compound creatives), compound creatives pose special challenges; these are outlined below.

One challenge is that of tracking (for automated billing and reporting). More particularly, it is typically easy to implement tracking of the container itself. However, with respect to compound creatives, tracking is desirable at the level of the subcreative as well; this proves to be more difficult than container tracking.

Another challenge is that of rotation. The implementer must decide if subcreatives should be constant in their relative positions or whether subcreatives may vary with each viewing of the compound advertisement. In addition, an ideal system would allow multiple levels of rotation: “container rotation,” i.e., a compound creative can rotate with other creatives (including other compound creatives), and “subcreative rotation,” i.e., subcreatives can rotate with other subcreatives within a given compound creative.

There are yet other challenges surrounding scheduling. With respect to scheduling, a system may require the individual instances of each compound creative to be scheduled separately, or it may support scheduling of the container and subcreatives independently.

Several implementations of compound creatives currently exist; these are outlined below.

Compound creatives may be generated manually. That is, HTML blocks are manually generated by a person (an “advertising administrator”) and are scheduled through the advertising system. In order to achieve subcreative rotation, each desired permutation must be individually generated. This approach requires significant human intervention, and therefore does not scale well; manually trying to create many compound creatives with many subcreatives can be achieved only at a high cost.

Another existing technology for implementing compound creatives uses a block of automatically generated web content. In this embodiment, a system creates a block of web content (typically HTML) that is retrieved directly from a web server without use of a standard advertising system. As considered herein, these blocks of web content are not creatives, since they are not part of an advertising system. They are, however, similar to creatives in that they are paid for by an advertiser seeking access to an audience. Such implementations lack one or more features commonly associated with full-featured ad systems such as filtered tracking, weighted rotation, flexible scheduling, reporting, integration with a billing system, etc.

A third method employed to display compound creatives is termed “associated creatives.” Using this method, the web page contains a group of related ad requests, which are resolved at runtime. Based on these requests, an advertising server dynamically chooses a set of results that fit some pre-defined constraints related to the ad request group. This approach may provide dynamic and tracked results, but with a non-negligible runtime performance cost. The performance penalty rises even higher if the compound creative needs to be formatted differently, according to how many subcreatives were returned. One vendor that supports this feature is Accipiter™ Ad Manager™ v6.

One ubiquitous application of compound creatives is the use of “paid search links.” Paid search links are served responsive to a user search request on a search engine such as Yahoo™ or Google™. The results pages of internet search engines supporting paid search links return a group of links, typically near the top of the search results pages, labeled “Sponsor Search Results.” These links are provided by a service such as Overture™, and may be considered compound creatives in that they are comprised of a container and subcreatives. However, the resulting compound creatives have several drawbacks, including: lack of rotation with other advertisements; text-only subcreatives; only a single group of subcreatives; and a limited degree of subcreative rotation.

Despite the match of both business need and technical suitability for advertising, no solutions are known to the present inventors which take full advantage of the Internet for advertising. In particular, the creation of compound creatives with many subcreatives currently requires either a very labor-intensive effort or a high runtime performance penalty. No solution is known to the present inventors which integrates the automatic generation of large volumes of customized, compound creatives with the flexible, dynamic delivery capabilities of a complete advertising system.

### SUMMARY OF THE INVENTION

In accordance with one aspect of the invention, the present inventors have developed methods and systems for automatically generating aggregate creatives, aggregate creatives comprising compound creatives having large numbers of subcreatives in the manner described in detail herein below.

In accordance with one aspect of the present invention there are provided methods and systems for the automated generation of aggregate creatives, one method comprising the steps of: receiving an aggregate creative definition; constructing a container in accordance with the aggregate creative definition; receiving a plurality of subcreatives associated with the aggregate creative definition for selective combination with the container; operating the aggregate creative definition to selectively assemble a plurality of aggregate creative forms, each of the plurality of aggregate creative forms comprising at least one combination of a selected subcreative from the plurality of subcreatives with the container; and storing the plurality of aggregate creative forms for transmission to users on an electronic network.

In accordance with another aspect of the present invention, there are provided methods and systems for serving aggregate creatives with an advertising system, comprising the steps of: receiving an aggregate creative definition for assembling an aggregate creative; receiving a plurality of subcreatives for selective combination with the aggregate creative definition; operating the aggregate creative definition to selectively assemble a plurality of aggregate creative forms; storing the plurality of aggregate creative forms; storing a plurality of non-aggregate creatives; and operating the advertising system to select one of the plurality of aggregate creative forms or one of the plurality of non-aggregate creatives for transmission to a viewer.

In accordance with other features and advantages of the invention, aggregate creatives provide for: automatic generation of large numbers of permutations; flexible, multi-level, weighted rotation; the application of constraints; efficient scheduling; subcreative tracking; and re-usable aggregate creative definitions. Subcreatives may be narrowly or widely targeted, and may be subject to formatting considerations. Methods and systems are provided for serving aggregate creatives over the Internet which take advantage of the benefits and features of the Internet to deliver those creatives in accordance with the capabilities of a standard advertising system.

### BRIEF DESCRIPTION OF THE DRAWING FIGURES

These and other objects, features and advantages of the present invention will be apparent from a consideration of the detailed description of the invention when read in conjunction with the drawing Figures, in which:

FIG. 1 is a block diagram showing an advertisement generation system connected to the Internet in accordance with the present invention;

FIG. 2 is a diagram illustrating the creation of a simple aggregate creative;

FIG. 3 is a flow chart showing an overview of a process for creating aggregate creatives;

FIG. 4 is a flow chart showing details of the aggregate creative information entry process in accordance with FIG. 3;

FIG. 5 is a flow chart showing details of the aggregate creative assembly process in accordance with FIG. 3;

FIG. 6 is a flow chart showing details of the aggregate creative serving process in accordance with FIG. 4; and

FIG. 7 is a diagram illustrating a more complex aggregate creative.

### DETAILED DESCRIPTION OF THE INVENTION

There will now be shown and described details of exemplary methods and systems for providing automatically generated aggregate creatives, that is, large volumes of programmatically-generated advertisements for electronic distribution and display over networks, the advertisements generated by an assembly process through the use of an aggregate creative definition, interactive with subcreatives and advertising data associated with an advertising system.

As noted above, the use of the term “creative” is used interchangeably with “advertisement.” As used herein, “aggregate creative” represents one type of electronic advertisement in which multiple advertisements appear together in one or more groups. An aggregate creative is an automatically generated compound creative which may rotate with other advertisements, and within which the set and/or order of displayed subcreatives may change with each viewing. A “subcreative” is an individual advertising message that is a member of an aggregate creative. A subcreative may comprise, for example, text, a hyperlink, an image, or other media. Each subcreative is selected from one or more “pools” of eligible subcreatives as described below. An “aggregate creative container,” or “container,” refers to all parts of the aggregate creative which are not a subcreative. A container may include, for instance, text, borders, background colors, etc.

An “aggregate creative form,” or “form,” is a single snapshot of an aggregate creative which has a particular set and order of displayed subcreatives. It will be seen that the present invention provides for the creation of multiple aggregate creative forms with different sets and/or orders of displayed subcreatives. One of these forms is subsequently chosen (possibly at random) by the advertising system for delivery with each page view, thereby providing subcreative rotation. As described earlier, each form is comprised of a container and one or more groups of zero or more subcreatives, the invention providing for rotation of subcreatives within a container and rotation of the aggregate creatives, at the container level, themselves.

As used herein, an “aggregate creative definition” is a representation of the structure and logic which, when combined with containers, subcreatives and advertising data during the assembly process, results in zero or more aggregate creative forms. An aggregate creative definition may be a template, a program, or other method of representing the necessary logic to rotationally select subcreatives for inclusion in an aggregate creative form. It is possible, for example, to implement an aggregate creative definition in terms of a programmable creative. See the above-described, related application, METHODS AND SYSTEMS FOR PROGRAMMABLY GENERATING ELECTRONIC CREATIVES FOR DISPLAY ON AN ELECTRONIC NETWORK.

A “subcreative pool,” or “pool,” is a set of subcreatives eligible for inclusion in an aggregate creative.

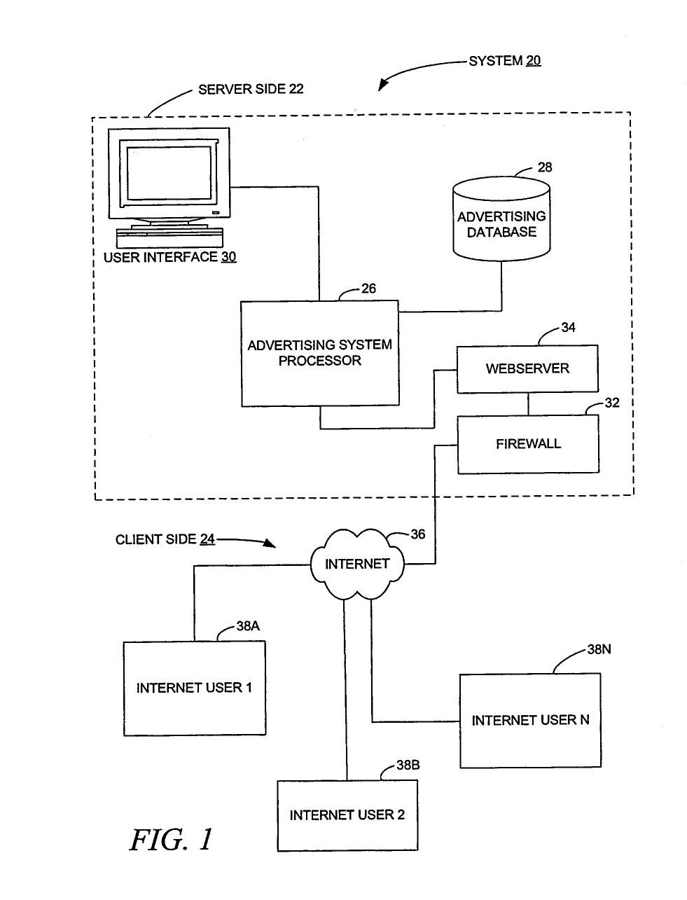

With reference now to FIG. 1 there is shown a network 20 of interconnected computer systems including a server-side system 22 and a plurality of client-side computer systems indicated generally at 24. In operation as described below, server-side system 22, owned and operated by a publisher, functions to transmit advertisements to client-side 24 viewers. Server-side system 22 includes an advertising system processor 26 connected to an advertising database 28, and a user interface 30. Advertising system processor 26 is further connected through a web server 34 and a security firewall 32 to a network such as Internet 36.

Advertising system processor 26 comprises any conventional computer, for example a personal computer, server or mainframe, capable of performing the functions described below. Similarly, advertising database 28 comprises any conventional storage system for storing the data described below as well as software for performing the processes of the present invention. Firewall 32 and web server 34 are conventional components known to those skilled in the art, the firewall providing network communications security and the web server providing a non-secure interface between client-side system 24 and server-side system 22.

Client-side systems 24 are seen to include multiple Internet users indicated at 38A, 38B, 38N. It will be appreciated that substantially any number of users may be connected to Internet 36 at any given time. It will be understood that Internet users 38A, B, N are connected to Internet 36 through conventional means, for example personal computers, personal digital assistants, cell phones or other systems enabling Internet browsing and downloading and viewing of Internet web pages.

Further included in advertising database 28 for execution on advertising system processor 26 is a standard advertising software system. As is well known in the art, such an advertising system uses the advertising data stored in advertising database 28 to select and serve creatives. Examples of standard advertising systems include Accipiter™ Ad Manager™, DoubleClick Ad Server™, AdRevolver™, et al. As described in further detail below, the advertising system is used in accordance with the present invention to select and serve both conventional creatives and aggregate creatives.

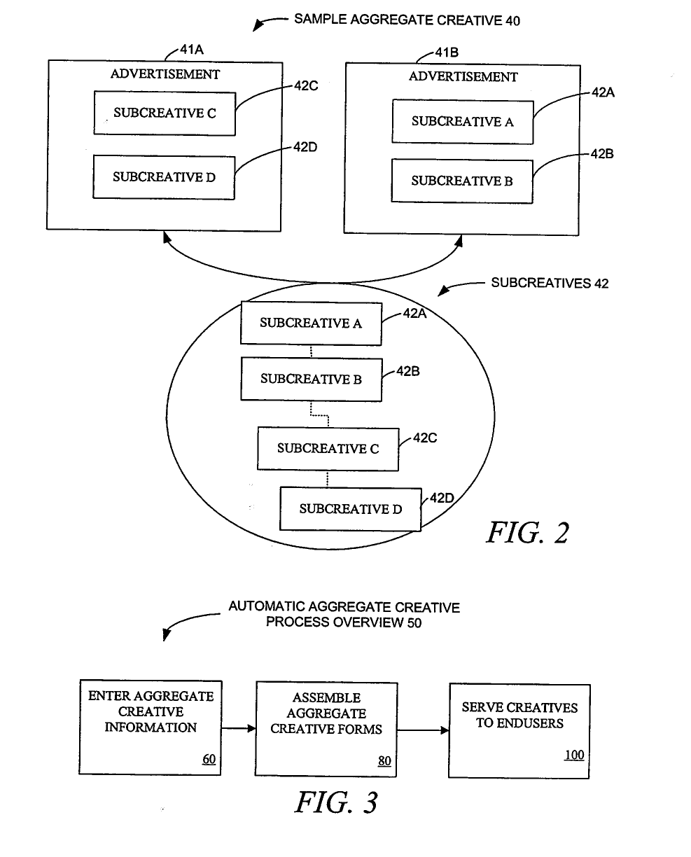

With reference now to FIG. 2, an exemplary aggregate creative 40 is shown in two particular instantiations, forms 41A and 41B. It will be understood that there may be more than two aggregate creative forms generated as output for this example, but only two are shown for the sake of clarity. Aggregate creative 40 contains within each form 41A and 41B container text, in this case the word “ADVERTISEMENT,” and two subcreatives. The subcreatives have been drawn from a pool 42 of subcreatives 42A, 42B, 42C and 42D. As illustrated, aggregate creative form 41A contains the two subcreatives 42C and 42D, while aggregate creative form 41B contains the two subcreatives 42A and 42B.

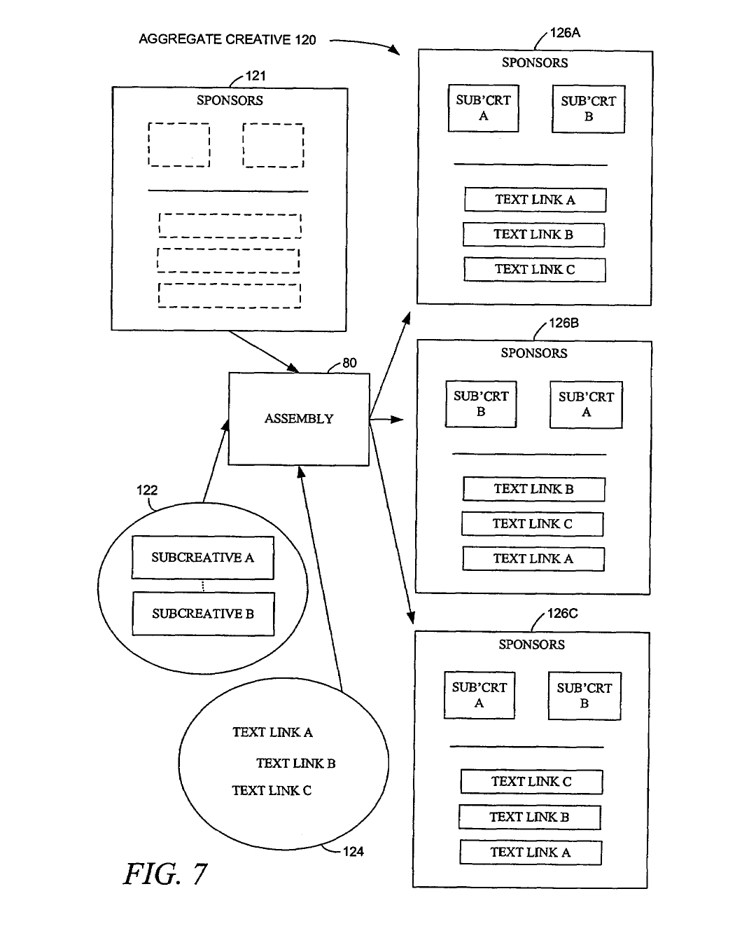

It will thus be understood that creatives generated in accordance with the present invention are termed “aggregate” creatives because each includes a container with one or more programmatically selected subcreatives, each representing an advertising message. A single aggregate creative is comprised of one or more forms, one of which will be chosen at runtime, thereby achieving subcreative rotation. It will be understood that the present invention contemplates a multitude of aggregate creative formats, exemplary ones of which are illustrated herein below. Many other arrangements are possible, including the use of more than one pool of subcreatives, as illustrated in FIG. 7 below. There will now be described in accordance with the present invention methods and systems for automatically generating, in accordance with aggregate creative definitions, aggregate creatives with large numbers of subcreatives.

With reference now to FIG. 3, an overview 50 of a process for automatically generating aggregate creatives is seen to include the steps of entering the aggregate creative information (step 60) including at least an aggregate creative definition, zero or more subcreatives, and advertising data, assembling the aggregate creative forms (step 80) in accordance with the definition and serving creatives to viewers (step 100), typically by transmitting them to the Internet users 38A-N in accordance with the advertising system run on server-side system 22 (see FIG. 1).

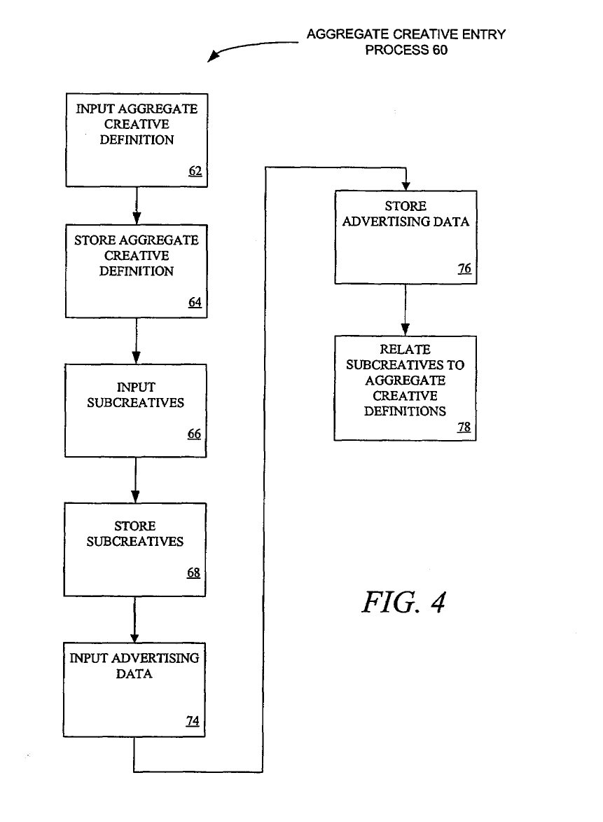

With reference now to FIG. 4, the process 60 for entering aggregate creative information includes first the steps of inputting certain information into advertising system processor 26 and storing that information in advertising database 28 (see FIG. 1). The information to be used for automatically assembling an aggregate creative, includes but is not limited to, the aggregate creative definition, input at step 62 and stored at step 64, and the subcreatives, input at step 66 and stored at step 68.

Continuing with reference to FIG. 4, advertising data for controlling the operation of the advertising system on system 20 (FIG. 1) is input into the advertising system processor at step 74 and stored in the advertising database at step 76. It will be understood that the particular order of data entry and storage is of no particular significance. However, the subcreatives are stored in association with one or more aggregate creative definitions (step 78) for the subsequent assembly of the aggregate creatives in accordance with the description below.

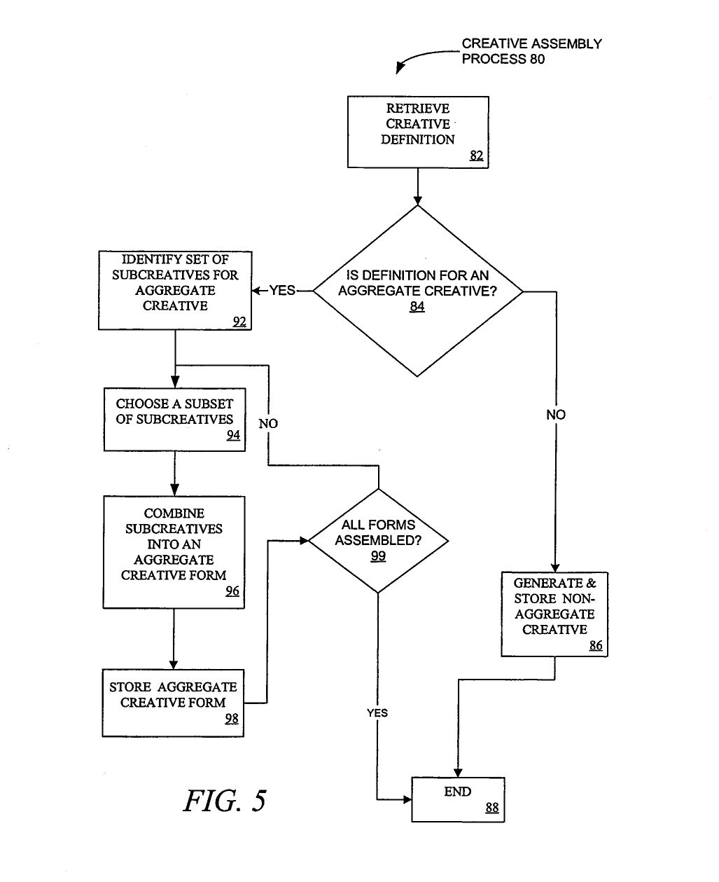

With reference now to FIG. 5, the process 80 for assembling aggregate creatives is shown wherein a creative definition is first retrieved from advertising database 28 (step 82). The definition is checked to determine if it is for an aggregate creative, that is, if it is flagged as the definition of an aggregate creative versus the definition of a conventional creative (step 84). If the definition is for a conventional creative (step 84), that creative is generated and stored for later use by the advertising system (step 86) and the process ends (step 88). The creative may be stored, for example, in advertising database 28 or at another convenient storage location, for example in a local or remote file system.

It will be understood that an aggregate creative definition may be invoked as a program, populated as a template, or otherwise operated on by this assembly process 80 to select subcreatives and rotationally integrate those subcreatives into aggregate creative forms (see FIG. 2, above). It will be understood that aggregate creative definitions can be specified in many different ways and provide many different results. For example, they may be templates embedded with flow control instructions to be processed by a special interpreter, data files (such as XML), or fully functional programs written in Perl, Java or in any software language capable of producing web-browser-readable text. This is in contrast to conventional creatives, whose definitions are generally HTML text which passes through the ad system mostly unchanged. As described below, the aggregate creative is integrated with the standard advertising system operated by server-side system 22.

Continuing with reference to FIG. 5, if the creative definition retrieved from storage is the definition of an aggregate creative (step 84), then the eligible subcreatives associated with that aggregate creative definition upon storage (see FIG. 4 above) are identified (step 92). The associated subcreatives, i.e. the subcreative pool(s) as illustrated in further detail below, are defined by the relationships entered during the aggregate creative entry process 60 described with respect to FIG. 4 above. The aggregate creative definition is operated, for each aggregate creative form that is to be generated, each time selecting one or more stored subcreatives from one or more pools of subcreatives in accordance with the definition (step 94), assembling the subcreatives and container into the aggregate creative form (step 96) and storing the aggregate creative form (step 98).

In accordance with the aggregate creative definition, the process of assembling aggregate creative forms (steps 94, 96 and 98) is repeated until the process ends (step 99), at which time the process of assembling the aggregate creative ends (step 88). It will be understood that the decision 99 to end the aggregate creative assembly process may take into account the number of forms required to fully display and rotate all subcreatives found in step 94.

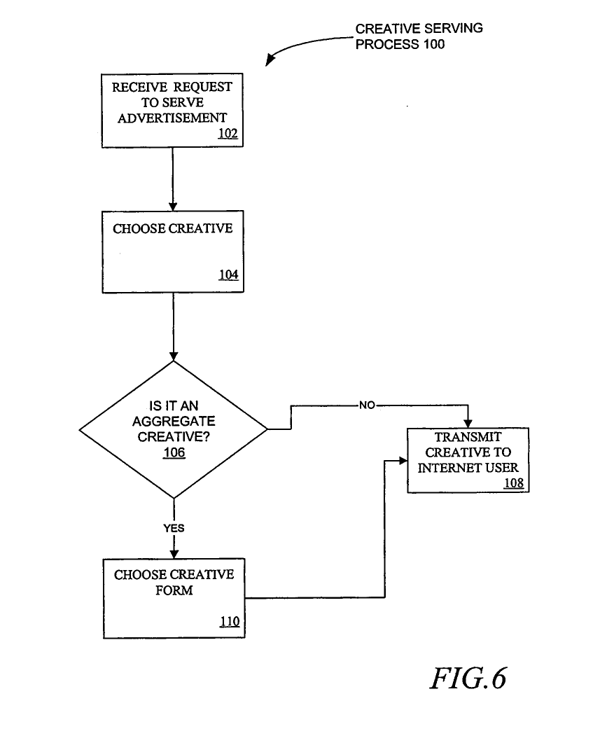

With reference to FIG. 6, the process 100 for serving creatives is shown to include the step of receiving a request to serve an ad (step 102) into an advertising system processor 26 from web server 34. A creative is selected (step 104) and, if the creative is not an aggregate creative (step 106), the non-aggregate creative is transmitted to the viewer in accordance with the advertising system direction (step 108). If the creative is an aggregate creative (step 106), an appropriate form of the aggregate creative is chosen (step 110) and is transmitted in accordance with the advertising system direction (step 108). With reference to step 110, it will be understood that this step is a modification of most standard advertising systems in accordance with the present invention, adding a layer of abstraction beyond a standard advertising creative. This extra layer comes with a slight runtime cost to performance, but a negligible cost when compared to a solution built with prior art technology of associated creatives. It will also be understood that the advertising server may choose the aggregate creative form randomly to achieve random rotation, or in a targeted manner for more specialized uses.

With reference to FIG. 7, another example of an aggregate creative 120 is shown. An aggregate creative definition 121 is seen pictorially in this view as a separate component, similar in nature to a programmable template into which subcreatives from two pools 122 and 124 are placed during the assembly process 80 described above with respect to FIG. 5. The output forms 126A, 126B, and 126C are the results of the assembly process 80, collectively illustrating one possible method of distributing subcreatives, the subcreatives in the described example comprising text and/or graphics A and B and textual hyperlinks A, B and C. It will be seen that the creative serving process 100 (FIG. 6) can achieve subcreative rotation simply by alternately choosing one of the forms 126A, B, C each time a user views a page.

In one embodiment of the invention, the aggregate creative definition is reusable for long periods of time, in different content areas, incorporating successively different sets of subcreatives. Towards simplifying system management, subcreative entries for use with aggregate creatives are provided to advertising system processor 26 in the same manner as the entry of any other, “conventional” creative. It is noted that the creatives entered as subcreatives may not only be used in aggregate creatives, but may also be used as non-aggregate creatives directly. Further, each subcreative may be scheduled to appear in zero or more instances of aggregate creatives' subcreative pools around the site or in a single specific area. A given subcreative may be scheduled against multiple pools, across the entire website, if desired. This is advantageous in that the same subcreative may be displayed as widely or as narrowly as desired.

There will now be described some exemplary operations of the subject invention. In one simple example, an aggregate creative includes a container and two subcreatives. In operation, following entry of the data (FIG. 4), the definition implementing the assembly process operates to create all output forms based on the aggregate creative definition combined with the two subcreatives. It will be apparent that the desired number of forms of each aggregate creative is dependent in a straight-forward manner, and in the broadest sense, on the size of the pool of subcreatives. For example, with a pool of 8 subcreatives, where the subcreatives are selected in groups of twos for combination within the container, at least 8 forms would be desired, with each subcreative residing in each position exactly once. It will be understood that other algorithms are possible, such as attaining a strict mathematical combination of all subcreatives, but such fine-grained rotation is not always necessary for typical business applications, and could carry a cost in system resources exponential to the number of subcreatives.

As the number of subcreatives increases, the number of desired forms increases proportionately. Currently, without the benefit of the present invention and using one of the methods noted above, it is necessary to create each form of a creative manually—a very time- and labor-intensive process. In accordance with the invention, the aggregate creative definition is interpreted automatically by an assembly process to generate a very large number of creative forms in a very short period of time. It will thus be seen that one advantage of the present invention over prior art, manual methods for assembling creatives, is the ability to automatically generate large numbers of aggregate creative forms from predetermined sets of data. Further, the aggregate creative forms can be regenerated off-line from the actual advertising serving as frequently as desired, for example to reorder the subcreatives, without negatively affecting the on-line system's performance.

It will further be understood that, in accordance with well-known advertising techniques, not all possible combinations of available subcreatives will be equally desirable. Well-known rules regarding desirable advertising campaigns, such as those relating to rotation, weighting, constraints and targeting, are included in the aggregate creative definition and/or the assembly process 80 as described below. Further, formatting issues are addressed to ensure appealing, readable advertisements.

With respect to rotation, as is well known in the art, an advertising sales team often expects that an impression count—that is, the number of times an advertisement is shown—will generally appear even over the course of an advertising campaign. Additionally, during the course of a single day, it may be preferred that a single advertiser does not get special positioning preference unless they have paid for that privilege. Rotation is meant to address these issues.

There are many possible rotation algorithms that would address these matters. In one exemplary solution there is provided a simple sliding approach. That is, the subcreatives in a pool are arranged into a circular list. When assembling the aggregate creative forms, the circular list of subcreatives is fully traversed in order, resulting in the property that each subcreative gets a chance (proportional to its weight, value, etc.) to be the first advertisement (that is, at the top of or otherwise prominently positioned within the advertisement) in a particular aggregate creative.

Continuing with the concept of rotation, when working with multiple pools of subcreatives, there will be multiple circular lists to traverse. It is possible to traverse the list of the largest pool once and the lists of the smaller pool(s) more than once. The traversal through each list of subcreatives thus happens independently of the other lists. FIG. 7 shows an example of rotation with two pools. It will be seen in this diagram with regards to the substance of the output forms that subcreative A attains the desirable top left position in two forms while peer subcreative B is in that position only once. This problem may be solved by (a) randomly shuffling the order of each pool's subcreatives before traversal, and (b) regenerating the randomized forms frequently throughout the day. At any given point in time, this does not solve the problem; some subcreatives will still get “short-changed.” However, throughout the day (or other period of advertising time), as the permutations are repeatedly regenerated, a new set of aggregate creative forms continually replaces the existing set, and the differences will statistically even out.

In summary, with respect to rotation, an ideal rotation algorithm should treat the subcreatives fairly with respect to ordering within each output form. Multiple pools of subcreatives are handled by looping once through the largest pool, and possibly more than once around the smaller pools. A desirable rotation algorithm might achieve even and equitable delivery over the day by randomly shuffling the pool before each generation, and by regenerating aggregate creative forms frequently throughout the day.

Weighting may be used if it is desired that some subcreatives get more visibility than others. Since subcreatives are treated the same as conventional, non-aggregate creatives, they may be assigned weights to give them a relative increase in the number of times they appear in output forms. In the context of aggregate creatives, the weight is used to copy the subcreative into the pool list multiple times, proportionally to the subcreative's weight, during assembly process 80 (step 94). During form assembly there is imposed, by default, the constraint (see below) that the same subcreative should not appear more than once in the same form; however, if this behavior is, for some reason, desired, the constraint can be removed. It will be understood that other frequency-adjusting mechanisms are conceivable, including, for example, a daily delivery goal.

A constraint is a business rule that may be applied to subcreatives, in order to filter their selection and hence control aggregate creative form content. Depending on the business application, constraints such as “No-Duplicate-Advertisers,” “No-Duplicate-Products,” “No-Duplicate-Advertising-Campaigns,” “No-Competing-Advertisers” etc. may be employed to protect the advertiser's messages from any unintended effects of automated rotation. For example, a computer manufacturer may have several different advertisements for the same product, and may not wish those messages to appear at the same time. In the prior art, the humans who manually generated the forms could observe such requests. In automated systems, in accordance with the present invention, constraints are used to achieve those results. Such constraints are enumerated within the aggregate creative definition and applied during the assembly process 80 (step 94).

It will be understood that there is no limit to the list of potential constraints that may be needed for business applications and that any number of constraints may be active at the same time.

It will be understood that the advertising data stored in advertising database 28 may include constraints, formatting considerations and other data or parameters which the aggregate creative definition may use during the assembly process. This is to say that constraints and other parameters may be specified on a per-aggregate-creative-definition basis, as well as on a per-set-of-advertising-data basis.

In summary with respect to weighting and constraints, weighting allows advertising administrators to configure particular subcreatives to appear more frequently than others. Constraints are business rules that may be applied to subcreatives to prevent the creation of undesirable aggregate creative forms.

To attain the goal of significantly reducing manual operations, the present invention enables an aggregate creative definition to be designed in such a way as to be reusable across multiple content areas, possible concurrently, thereby avoiding unnecessary rewrites. Thus, instead of designing an aggregate creative definition for only one particular content area, the creator may determine attributes such as label or color from dynamic association with different targets—a powerful and time-saving feature.

Subcreatives may participate in more than one aggregate creative or subcreative pool at the same time. Advertisers thus have a flexible choice in targeting scope: the ability to buy a subcreative that remains narrowly targeted in one particular advertising channel or one that is targeted more generally through a larger collection of advertising channels.

One method of supporting the ability to place the same subcreative into different advertising channels is to forbid the scheduled overlapping of aggregate creatives and place a dynamic association in the advertising system: a relationship between a particular, scheduled instance of an aggregate creative and the specifically desired pools of subcreatives for that instance.

In summary with respect to advertisement targeting flexibility, aggregate creative definitions can be relocated to and/or reused in different content areas, and subcreatives can run in one or more aggregate creative instances. To attain the benefits of this feature, the advertising system must support an association between the aggregate creative definition and the associated subcreatives (see FIG. 4, step 78) as described with respect to the present invention.

To protect the aesthetic formatting of a web page, an ideal implementation of the aggregate creative definition and assembly process 80 will have the ability to define “special cases” with respect to subcreative pools. Such special cases include having no subcreatives available, or having fewer than enough subcreatives available to fill all open positions within an aggregate creative definition. Such special cases require specific logic within the aggregate creative definition such that the formation of aesthetically pleasing web pages is ensured. For example, an aggregate creative may be designed to place two subcreatives into two HTML table calls; but if only one subcreative is available, the definition may specify in that special case to forego the table and simply center the single subcreative. An exemplary implementation of the invention handles these scenarios by allowing the aggregate creative definition to include program flow control statements.

There has thus been provided new and improved methods and systems for generating aggregate creatives having scaling benefits as compared to the manual creation of aggregate creatives, and run-time performance benefits as compared to a solution built with the associated creative feature. In comparison to the automated generation of web content, the present invention provides flexibility to adjust to different advertising-specific needs. Further provided are rotation of the aggregate creative with other ad units, weighted rotation of sub creatives within the aggregate, individually tracked subcreatives of any browser-supported format or media, multiple pools of subcreatives, automated constraints between subcreatives, reuse of aggregate creative definitions, and the ability for advertisers to target subcreatives narrowly or generally across the site. The present invention has application in the generation of creatives for electronic advertising.

While the present invention has been described with respect to particular examples and embodiments, it is not thus limited. Numerous changes, modifications, enhancements and improvements falling within the scope, of the invention will now occur to those skilled in the art.

1-45. (canceled)

46. A method for generating electronic advertising, comprising:
receiving, at a server-side computer system, a definition for an aggregate creative that presents a combination of subcreatives to a user on a client-side computer system, the definition programming the aggregate creative to be updated on the client-side computer system in response to user input relative to one or more of the subcreatives;
selecting, at the server-side computer system, a selected combination of subcreatives according to the definition;
assembling, at the server-side computer system, the selected combination of subcreatives into an aggregate creative form according to the definition; and
transmitting, from the server-side computer system, the aggregate creative form over a network to the client-side computer system for presentation on the client-side computer system.

47. The method according to claim 46, wherein the combination of subcreatives includes at least one hyperlink to additional content, and the aggregate creative is updated to present the additional content in response to the user clicking the at least one hyperlink.

48. The method according to claim 47, further comprising transmitting, from the server-side computer system, the additional content to the client-side computer system, the additional content being presented by the aggregate creative.

49. The method according to claim 48, wherein the additional content includes proprietary data stored in a server-side private database.

50. The method according to claim 47, wherein the additional content includes video content, and the user clicks the at least one hyperlink to select the video content.

51. The method according to claim 50, wherein the video content is stored on the server-side system.

52. The method according to claim 46, wherein selecting the selected combination of subcreatives includes selecting from a plurality of possible combinations of stored subcreatives.

53. The method according to claim 46, wherein selecting the selected combination and assembling the selected combination are repeated to generate a plurality of aggregate creative forms according to the definition, and the transmitted aggregate creative form is selected from the plurality of aggregate creative forms.

54. The method according to claim 53, wherein the transmitted aggregate creative form is selected from the plurality of aggregate creative forms according to one or more rules that determine how the plurality of aggregate creative forms are presented on a plurality of client-side computer systems.

55. The method according to claim 54, wherein the transmitted aggregate creative form is selected from the plurality of aggregate creative forms according to a rotation.

56. A method for generating electronic advertising, comprising:
receiving, at a client-side computer system, an aggregate creative form over a network from a server-side computer system, the aggregate creative form presenting a combination of subcreatives to a user on a client-side computer system, the combination of subcreatives being assembled on the server-side computer system according to a definition for an aggregate creative;
displaying, at the client-side computer system, the aggregate creative form;
receiving, at the client-side computer system, an input from the user relative to one or more of the subcreatives; and
updating, on the client-side computer system, the aggregate creative form in response to the input from the user.

57. The method according to claim 56, wherein the combination of subcreatives includes at least one hyperlink to additional content, the input from the user includes clicking the at least one hyperlink, and updating the aggregate creative includes presenting the additional content in response to the input.

58. The method according to claim 57, further comprising receiving, at the client-side computer system, the additional content from the server-side computer system.

59. The method according to claim 58, wherein the additional content includes proprietary data stored in a server-side private database.

60. The method according to claim 57, wherein the additional content includes video content, and the user clicks the at least one hyperlink to select the video content.

61. The method according to claim 60, wherein the video content is stored on the server-side computer system.

62. The method according to claim 56, wherein the combination of subcreatives is selected from a plurality of possible combinations of stored subcreatives.

63. The method according to claim 56, wherein the server-side system generates a plurality of aggregate creative forms according to the definition, and the received aggregate creative form is selected from the plurality of aggregate creative forms.

64. The method according to claim 63, wherein the received aggregate creative form is selected from the plurality of aggregate creative forms according to one or more rules that determine how the plurality of aggregate creative forms are presented on a plurality of client-side computer systems.

65. The method according to claim 64, wherein the received aggregate creative form is selected from the plurality of aggregate creative forms according to a rotation.

66. A method for generating electronic advertising, comprising:
receiving, at a server-side computer system, a definition for an aggregate creative that presents a combination of subcreatives to a user on a client-side computer system, the subcreatives providing hyperlinks to video content, and in response to the selection of one of the subcreatives by the user, the aggregate creative presenting the video content corresponding to the selected subcreative;
selecting, at the server-side computer system, the combination of subcreatives according to the definition;
assembling, at the server-side computer system, the combination of subcreatives into an aggregate creative form according to the definition; and
transmitting, from the server-side computer system, the aggregate creative form over a network to the client-side computer system for presentation on the client-side computer system.

67. A system for generating electronic advertising, comprising:
a computer-readable storage media that stores a definition for an aggregate creative, the definition determining a combination of subcreatives for the aggregate creative and programming the aggregate creative to be updated on a client-side computer system in response to input from a user relative to one or more of the subcreatives; and
a server-side computer that reads the definition from the computer-readable storage media, assembles the combination of subcreatives to form an aggregate creative form, and transmits the aggregate creative form over a network to the client-side computer, the client-side computer displaying the aggregate creative form on a display.

68. The system according to claim 67, wherein the combination of subcreatives includes at least one hyperlink to additional content, and the aggregate creative is updated to present the additional content in response to the user clicking the at least one hyperlink.

69. The system according to claim 68, wherein the additional content is stored on other server-side computer-readable storage media, and the server-side computer transmits the additional content to the client-side computer system in response to the input from the user.

70. The system according to claim 69, wherein the additional content includes proprietary data stored in a private database on the other server-side computer-readable storage media.

71. The system according to claim 68, wherein the additional content includes video content, and the user clicks the at least one hyperlink to select the video content.

72. The system according to claim 71, wherein the video content is stored on other server-side computer-readable storage media.

73. The system according to claim 67, wherein server-side computer selects the combination of subcreatives from a plurality of possible combinations of stored subcreatives stored on other server-side computer-readable storage media.

74. The system according to claim 67, wherein the server-side computer generates a plurality of aggregate creative forms according to the definition, stores the plurality of aggregate creative forms on other server-side computer-readable storage media, and selects the transmitted aggregate creative form from the plurality of aggregate creative forms.

75. The system according to claim 74, wherein the server-side computer selects the transmitted aggregate creative form from the plurality of aggregate creative forms according to one or more rules that determine how the plurality of aggregate creative forms are presented on a plurality of client-side computer systems.

76. The system according to claim 75, wherein the server-side computer selects the transmitted aggregate creative form from the plurality of aggregate creative forms according to a rotation.

77. A system for generating electronic advertising, comprising:
a computer-readable storage media that receives an aggregate creative form received from a server-side computer, the aggregate creative form presenting a combination of subcreatives, the combination of subcreatives being assembled on the server-side computer according to a definition for an aggregate creative; and
a client-side computer that reads the aggregate creative form from the computer-readable storage media, the client-side computer including a display that displays the aggregate creative form and a input-receiving device that receives an input from a user relative to one or more of the subcreatives, and the client-side computer system updating the aggregate creative form in response to the input from the user.

78. The system according to claim 77, wherein the combination of subcreatives includes at least one hyperlink to additional content, the input from the user includes clicking the at least one hyperlink, and the client-side computer updates the aggregate creative by presenting the additional content in response to the input.

79. The system according to claim 78, wherein the additional content is stored in server-side computer-readable storage media, and the client-side computer receives the additional content from the server-side computer.

80. The system according to claim 79, wherein the additional content includes proprietary data stored in a server-side private database on server-side computer-readable storage media.

81. The system according to claim 78, wherein the additional content includes video content, and the user clicks the at least one hyperlink to select the video content.

82. The system according to claim 81, wherein the video content is stored on server-side computer-readable storage media.

83. The system according to claim 77, wherein the combination of subcreatives is selected from a plurality of possible combinations of stored subcreatives.

84. The system according to claim 77, wherein the server-side computer generates a plurality of aggregate creative forms according to the definition and stores the plurality of aggregate creative forms on server-side computer-readable storage media, and the received aggregate creative form is selected from the plurality of aggregate creative forms.

85. The system according to claim 84, wherein the received aggregate creative form is selected from the plurality of aggregate creative forms according to one or more rules that determine how the plurality of aggregate creative forms are presented on a plurality of client-side computer systems.

86. The system according to claim 85, wherein the received aggregate creative form is rotatively selected from the plurality of aggregate creative forms according to a rotation.

87. A system for generating electronic advertising, comprising:
a computer-readable storage media that stores a definition for an aggregate creative, the definition determining a combination of subcreatives for the aggregate creative, the subcreatives providing hyperlinks to video content, the definition programming the aggregate creative to respond to the selection of one of the subcreatives by a user on a client-side computer by presenting the video content corresponding to selected subcreative; and
a server-side computer that reads the definition from the computer-readable storage media, assembles the combination of subcreatives to form an aggregate creative form, and transmits the aggregate creative form over a network to the client-side computer, the client-side computer displaying the aggregate creative form on a display.
